(19) United States
(12) Patent Application Publication
(10) Pub. No.: US 2026/0038738 A1
(43) Pub. Date: Feb. 5, 2026

(54) CAPACITORS AND METHODS FOR MANUFACTURING THE SAME

(71) Applicant: Samsung Electronics Co., Ltd., Suwon-si (KR)

(72) Inventor: Inyeol Yun, Suwon-si (KR)

(21) Appl. No.: 19/048,275

(22) Filed: Feb. 7, 2025

(30) Foreign Application Priority Data
Jul. 31, 2024 (KR) 10-2024-0101819

(51) Int. Cl. H01G 4/232; H01G 4/32

(52) U.S. Cl. CPC H01G 4/232; H01G 4/32

(57) ABSTRACT

A capacitor includes: a capacitor body including a dielectrics structure and a plurality of internal electrodes, each of which are embedded in the dielectrics structure and spaced apart from one another in a direction from a side surface of the dielectrics structure to an interior of the dielectrics structure; and an external electrode disposed on the capacitor body and connected to the internal electrodes; wherein each of the plurality of internal electrodes circumferentially surrounds another internal electrode disposed further inside of the dielectrics structure.

### CROSS-REFERENCE TO RELATED APPLICATION

This application claims priority under 35 U.S.C. Section 119 to, and the benefit of, Korean Patent Application No. 10-2024-0101819 filed in the Korean Intellectual Property Office on Jul. 31, 2024, the entire contents of which are incorporated herein by reference.

### FIELD

The present disclosure relates to capacitor devices and methods for manufacturing the same.

### BACKGROUND

With progress in mobile and wearable devices, the size of electronic devices is getting smaller, and the performance of APs (application processors) is being maximized. Thus, down-sizing, thin-filming, and low ESL (equivalent series inductance) characteristics are required for capacitors mounted on a lower surface of the AP package to perform functions of electric power backup and AC noise bypass of the AP package.

Conventional multi-layered ceramic capacitors (MLCC) can be manufactured by stacking dielectrics sheets and internal electrode sheets in a vertical direction from the lower surface and firing them to form a capacitor body, and then forming external electrodes on both side surfaces of the capacitor body.

### SUMMARY

In an aspect, the present disclosure provides a capacitor capable of reducing a mounting area and increasing degree of freedom in mounting.

In another aspect, the present disclosure reduces depopulation of solder balls due to capacitors.

In another aspect, the present disclosure provides a capacitor having a low ESL (equivalent series inductance) characteristics.

According to some embodiments, a capacitor includes: a capacitor body including a dielectrics structure and a plurality of internal electrodes embedded in the dielectrics structure and spaced apart from one another in a direction from a side surface of the dielectrics structure to inside of the dielectrics structure; and an external electrode disposed on the capacitor body and connected to the internal electrodes, and wherein each of the plurality of internal electrodes circumferentially surrounds another internal electrode disposed further inside of the dielectrics structure.

According to some embodiments, a capacitor includes: a capacitor body including an axial core, a dielectrics structure surrounding the axial core, a plurality of first internal electrodes embedded in the dielectrics structure and each including a respective first terminal exposed at an upper surface of the dielectrics structure, and a plurality of second internal electrodes embedded in the dielectrics structure, insulated from the first internal electrodes, and each including a respective second terminal exposed at the upper surface of the dielectrics structure; and first and second external electrodes disposed on the capacitor body, wherein the first external electrode is connected to the first terminal and the second external electrode is connected to the second terminal.

According to some embodiments, a capacitor manufacturing method includes: forming a capacitor body by alternately winding dielectrics sheets and internal electrode sheets around an axial core, each of the internal electrode sheets including a respective terminal; and forming an external electrode connected to the terminals on the capacitor body, wherein the forming the capacitor body includes arranging the dielectrics sheets and the internal electrode sheets spaced apart from each other in a first direction on a base, and winding the dielectrics sheets and the internal electrode sheets around the axial core.

According to an aspect of the present disclosure, a capacitor capable of reducing mounting area and increasing the degree of freedom in mounting can be provided.

According to another aspect of the present disclosure, depopulation of solder balls due to capacitors can be reduced.

According to another aspect of the present disclosure, a capacitor having low ESL characteristics can be provided.

### BRIEF DESCRIPTION OF THE DRAWINGS

FIG. 1 is a perspective view of a capacitor according to some embodiments of the present disclosure.

FIG. 2 is a perspective view of the capacitor body of FIG. 1.

FIG. 3 is a top view of the capacitor shown in FIG. 1.

FIG. 4 is a cross-sectional view of the capacitor shown in FIG. 1 taken along the line 4-4 of FIG. 3.

FIG. 5 is a cross-sectional view of a capacitor according to further embodiments of the present disclosure.

FIG. 6 is a cross-sectional view of a capacitor according to further embodiments of the present disclosure.

FIG. 7 shows a region of a substrate on which a capacitor according to further embodiments of the present disclosure is mounted.

FIG. 8 shows a region of a substrate on which the capacitor according to Comparative Example 1 is mounted.

FIG. 9 shows a region of a substrate on which the capacitor according to Comparative Example 2 is mounted.

FIG. 10 is a table comparing capacitors according to some embodiments and Comparative Example 2.

FIG. 11 shows a region of a substrate on which the capacitor according to an embodiment of the present disclosure is mounted.

FIG. 12 shows a region of the substrate on which the capacitor according to Comparative Example 2 is mounted.

FIG. 13 shows a region of a substrate on which a capacitor according to an embodiment of the present disclosure is mounted together with solder balls having small pitches.

FIG. 14 shows a region of a substrate on which a capacitor according to Comparative Example 2 is mounted together with solder balls having small pitches.

FIG. 15 is a drawing illustrating a method for manufacturing a capacitor body according to some embodiments of the present disclosure.

FIG. 16 to FIG. 21 are perspective views of the capacitor body in each of the manufacturing steps.

FIG. 22 is a drawing illustrating the process of forming external electrodes on a capacitor body.

FIG. 23 and FIG. 24 illustrate example methods for forming a molding material on a capacitor body.

### DETAILED DESCRIPTION

Hereinafter, with reference to accompanying drawings, various embodiments of the present disclosure will be described in detail so that a person of an ordinary skill can easily implement the present disclosure. The present disclosure may be implemented in many different forms and is not limited to the embodiments described herein.

In order to clearly explain the present disclosure, parts that are not relevant to the description are omitted, and identical or similar components are assigned the same reference numerals throughout the specification (including in different embodiments).

In addition, the size and thickness of each component shown in the drawings are shown arbitrarily for convenience of explanation, so the present disclosure is not necessarily limited to what is shown. In the drawings, the thickness of layers, films, panels, regions, etc., are exaggerated for clarity. And in the drawings, for convenience of explanation, the thicknesses of some layers and regions are exaggerated.

Throughout the specification, when a part is said to be “connected” to another part, this includes not only “directly connected” but also “indirectly connected” through another member. In a similar sense, this includes being “physically connected” as well as being “electrically connected”.

It will be understood that when an element such as a layer, film, region, or substrate is referred to as being “on” another element, it can be directly on the other element or intervening elements may also be present. In contrast, when an element is referred to as being “directly on” another element, there are no intervening elements present. In addition, being “on” or “above” a reference element means being positioned on or below the reference element, and does not necessarily mean being positioned “above” or “on” in a direction opposite to gravity.

In addition, unless explicitly described to the contrary, the word “comprise”, and variations such as “comprises” or “comprising”, will be understood to imply the inclusion of stated elements but not the exclusion of any other elements.

In addition, throughout the specification, when referring to “a plane view”, it means that the target portion is viewed from above, and when referring to “a cross-section view”, it means that a cross section of the target portion cut vertically is viewed from a side.

In addition, throughout the specification, sequential numbers such as first and second are used to distinguish a certain component from other components that are the same or similar to the component, and are not necessarily intended to refer to a specific component. Accordingly, a component referred to as a first component in a specific part of this specification may be referred to as a second component in other parts of this specification.

As used herein, “monolithic” means an object that is a single, unitary piece formed or composed of a material without joints or seams.

Additionally, throughout the specification, references to a single element include references to a plurality of the element, unless specifically stated to the contrary. Similarly, a reference to a plurality of components may include a single component.

Hereinafter, capacitors and their manufacturing methods according to embodiments of the present disclosure will be described with reference to the drawings.

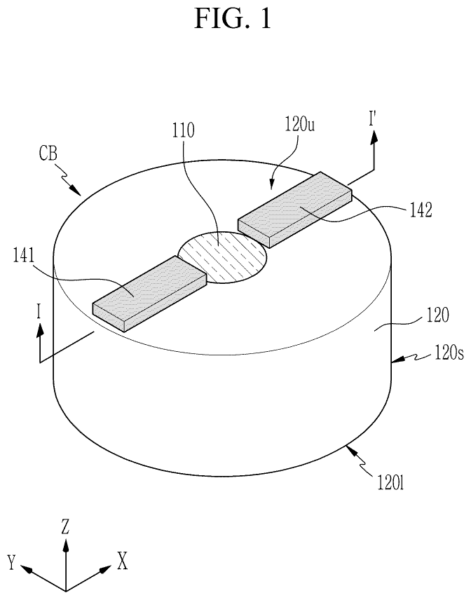

FIG. 1 is a perspective view of a capacitor 100A according to some embodiments of the present disclosure.

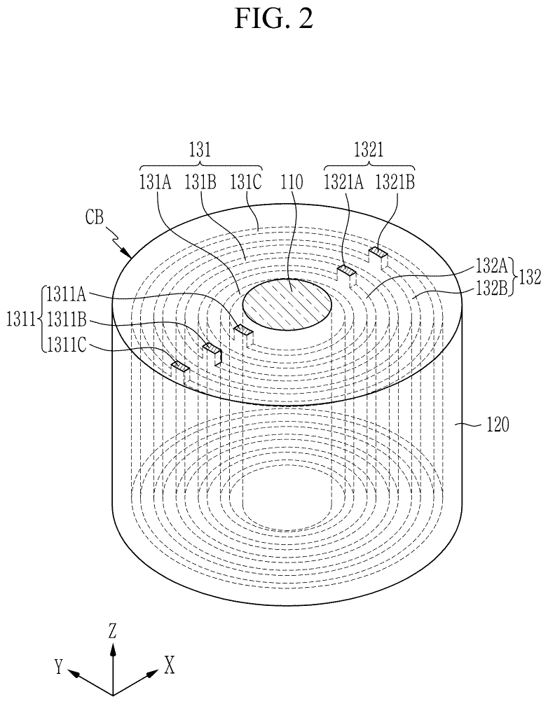

FIG. 2 is a perspective view of the capacitor body of FIG. 1.

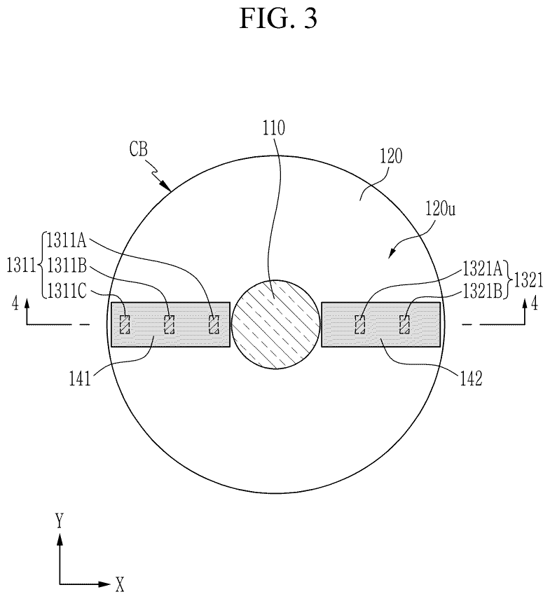

FIG. 3 is a top view of the capacitor 100A shown in FIG. 1.

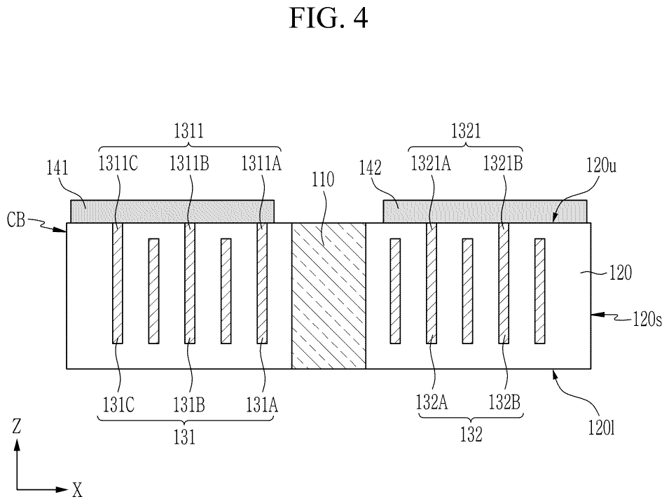

FIG. 4 is a cross-sectional view of the capacitor 100A shown in FIG. 1.

Referring to FIG. 1 to FIG. 4, the capacitor 100A may include an axial core 110, a dielectrics structure 120, internal electrodes 131, 132 (respectively including terminals 1311, 1321), and external electrodes 141, 142.

The dielectrics structure 120 in combination with the axial core 110 and the internal electrodes 131, 132 embedded in the dielectrics structure 120 form a capacitor body CB of the capacitor 100A.

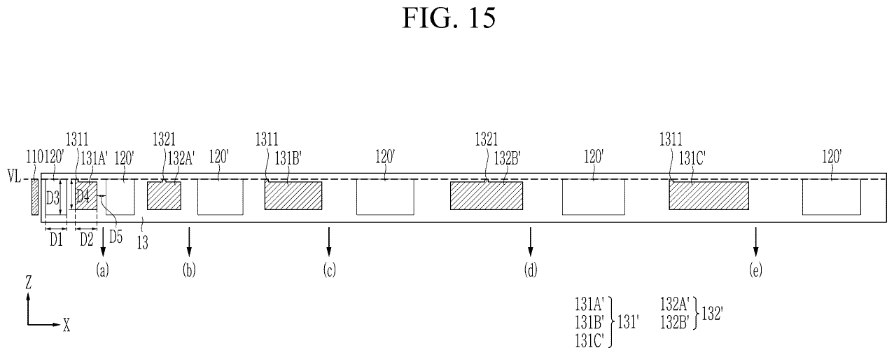

The axial core 110 is at least partially embedded in the dielectrics structure 120, and may function as a support structure for forming the dielectrics structure 120 and internal electrodes 131, 132 when forming the capacitor body CB. For example, referring to FIG. 15, a capacitor body CB may be formed by alternately winding dielectric material sheets 120′ (which form a dielectrics structure 120) and internal electrode sheets 131′, 132′ (which form internal electrodes 131, 132) around the axial core 110, and the axial core 110 may be a support structure for winding the dielectric material sheets 120′ and the internal electrode sheets 131′, 132′.

In order to support the entire area of the dielectric material sheets 120′ and the internal electrode sheets 131′, 132′ when forming the capacitor body CB, the length of the axial core 110 in the Z direction (Z) may be equal to or longer than the length of the dielectrics structure 120 and the internal electrodes 131′, 132 in the Z direction (Z). Therefore, the axial core 110 may be exposed to the upper surface 120u and the lower surface 1201 of the dielectrics structure 120. For example, the axial core 110 may protrude from the upper surface 120u and/or the lower surface 1201 of dielectrics structure 120. However, from a perspective of thin-filming the capacitor 100A, it may be preferable that the upper surface of the axial core 110 is coplanar with the upper surface 120u of the dielectrics structure 120 and/or the lower surface of the axial core 110 is coplanar with the lower surface 1201 of the dielectrics structure 120.

The axial core 110 may be cylindrical. By use of a cylindrical axial core 110, dielectric material sheets 120′ and internal electrode sheets 131′, 132′ are cylindrically wound about the circumference of the axial core 110, so that a cylindrical capacitor may be easily provided.

An insulating material may be used as a material for the axial core 110. Additionally, the axial core 110 may be formed of a material with low reactivity to prevent reaction with adjacent components. For example, the axial core 110 may contain silicon.

Depending on the manufacturing method of the capacitor, the axial core 110 may be omitted. For example, the capacitor may be constructed such that a dielectrics structure 120 fills the interior of the capacitor, instead of the axial core 110. As another example, the capacitor may have a hollow cylindrical shape with the axial core 110 removed or omitted.

The dielectrics structure 120 surrounds the axial core 110 and may form the exterior or outer shape of the capacitor body CB. Therefore, the upper surface 120u, the side surface 120s, and the lower surface 1201 of the dielectrics structure 120 may form a upper surface, a side surface, and a lower surface of the capacitor body CB, respectively.

The dielectrics structure 120 may be cylindrical. By forming the dielectrics structure 120, which forms the exterior shape of the capacitor body CB, in a cylindrical shape, a capacitor with a small mounting area may be provided as described below.

The dielectrics structure 120 may fill the space between adjacent internal electrodes 131, 132, for example between a first internal electrode 131 and a second internal electrode 132 to separate them from each other. For example, respective portions of the dielectrics structure 120 may fill the spaces between the first internal electrode 131A and the second internal electrode 132A, between the second internal electrode 132A and the first internal electrode 131B, between the first internal electrode 131B and the second internal electrode 132B, and between the second internal electrode 132B and the first internal electrode 131C to separate the adjacent internal electrodes 131, 132 from each other.

The regions of the dielectrics structure 120 filling the spaces between adjacent internal electrodes 131, 132 may be integral, and may not have a visually recognizable boundary between them. For example, a region of the dielectrics structure 120 filling between the first internal electrode 131A and the second internal electrode 132A, a region filling between the second internal electrode 132A and the first internal electrode 131B, a region filling between the first internal electrode 131B and the second internal electrode 132B, and a region filling between the second internal electrode 132B and the first internal electrode 131C may not have boundaries with each other. In some embodiments, the dielectrics structure 120 is monolithic.

Also, the dielectrics structure 120 may fill a space between the innermost internal electrode 131A of the internal electrodes 131, 132 and the axial core 110, and/or cover the outermost internal electrode 131C.

As the material of dielectrics structure 120, an insulating material, for example, a ceramic such as barium titanate (BaTiO3), may be used.

Internal electrodes 131, 132 may be embedded in the dielectrics structure 120.

The internal electrodes 131, 132 each surround the axial core 110 and may be spaced apart from each other in a direction away (i.e., radially) from the axial core 110. Using the side surface 120s of the dielectrics structure 120 as a reference or starting point, it can be understood that the internal electrodes 131,132 are spaced apart from each other in a direction from the side surface 120s of the dielectrics structure 120 to the inside of the dielectrics structure 120 (i.e., a radial direction toward the axial core 110). As described above, by winding internal electrode sheets 131′, 132′ together with the dielectrics sheets 120′ around the axial core 110 to form the internal electrodes 131, 132, a construction or structure may be formed wherein the internal electrodes 131, 132 each surround the axial core 110 and are spaced apart from each other in a direction away from the axial core 110.

Also, each of the internal electrodes 131, 132 may circumferentially surround one or more other internal electrodes 131, 132 disposed further inside. For example, referring to FIG. 2, the internal electrode 132A may surround the internal electrode 131A disposed innermost among the internal electrodes 131, 132, the internal electrode 131B may surround the internal electrodes 131A, 132A disposed further inside, the internal electrode 132B may surround the internal electrodes 131A, 132A, and 131B disposed further inside the capacitor body CB, and the internal electrode 131C may surround the internal electrodes 131A, 132A, 131B, 132B disposed further inside.

The internal electrodes 131, 132 may include first internal electrode(s) 131 and second internal electrode(s) 132 that are electrically insulated from each other. The first internal electrode 131 and the second internal electrode 132 may be physically separated from each other and/or electrically insulated by the dielectrics structure 120.

In some embodiments, the first internal electrodes 131 and the second internal electrodes 132 may be alternately arranged in a direction away from the axial core 110. For example, the first internal electrodes 131 and the second internal electrodes 132 may include a first internal electrode 131A, a second internal electrode 132A, a first internal electrode 131B, a second internal electrode 132B and a first internal electrode 131C, which are sequentially arranged in a direction away from the axial core 110. However, the number of first internal electrodes 131 and second internal electrodes 132 shown in the drawing is an example, and the number of the first internal electrodes 131 and second internal electrodes 132 is not limited thereto. Also, the number of the first internal electrodes 131 and the number of the second internal electrodes 132 may be the same or different.

Depending on embodiments, the first internal electrodes 131 and the second internal electrodes 132 may be arranged in different ways. For example, the first internal electrodes 131 may be disposed at an inner region of the dielectrics structure 120 adjacent to the axial core 110, and the second internal electrodes 132 may be disposed in an outer region of the dielectrics structure 120 including the side surfaces 120s.

Each of the internal electrodes 131, 132 may include terminals 1311, 1321 providing electrical connections between the internal electrodes 131, 132 and the external electrodes 141, 142.

The terminals 1311, 1321 are exposed to the upper surface 120u of the dielectrics structure 120 and may be connected to external electrodes 141, 142. For example, each of the first internal electrodes 131 may include a first terminal 1311 exposed to or at the upper surface 120u of the dielectrics structure 120, and each of the second internal electrodes 132 may include a second terminal 1321 exposed to or at the upper surface 120u of the dielectrics structure 120. The terminals 1311, 1321 may have a structure that protrudes upward compared to or beyond other portions of internal electrodes 131, 132. Since the first terminal 1311 and the second terminal 1321 are exposed to or at or project from the same surface (i.e., upper surface 120u) of the dielectrics structure 120, the external electrodes 141, 142 connected to them may be formed on the same surface of the dielectrics structure 120. Therefore, the increase in size of the capacitor due to the arrangement of external electrodes 141, 142 can be minimized. Additionally, since the distance between the external electrodes 141, 142 is short, a capacitor having a low ESL (equivalent series inductance) characteristic can be provided.

On the upper surface 120u of the dielectrics structure 120, the first terminals 1311 and the second terminals 1321 may be arranged in opposite lateral or radial directions with respect to the axial core 110 or on opposite sides of the axial core 110. In other words, on the upper surface 120u of the dielectrics structure 120, the axial core 110 may be disposed between the first terminals 1311 and the second terminals 1321. For example, referring to FIG. 3, the first terminals 1311 may be arranged on the left side of the axial core 110, and the second terminals 1321 may be arranged on the right side of the axial core 110. By arranging the first terminals 1311 and the second terminals 1321 in opposite directions with respect to the axial core 110, easy connection between the terminals 1311, 1321 and the external electrodes 141, 142 may be provided and electric shorts between components requiring electrical insulation may be prevented.

In some embodiments, the internal electrodes 131, 132 are not exposed to or at the lower surface 1201 of the dielectrics structure 120 where the external electrodes 141, 142 are not disposed, and thus may be physically and chemically protected by the dielectrics structure 120, and may be prevented from an electric short.

As materials for each of the internal electrodes 131, 132, conductive materials may be used.

For example, nickel (Ni), copper (Cu), silver (Ag), tin (Sn), palladium (Pd), gold (Au), platinum (Pt), or metal alloys containing two or more of those may be used for the internal electrodes 131, 132.

The external electrodes 141, 142 are arranged on the capacitor body CB to be connected to the internal electrodes 131, 132, and may provide electrical connection between the capacitor 100A and an external component (e.g., AP package substrate).

The external electrodes 141, 142 may be respectively arranged on the upper surface 120u of the dielectrics structure 120 of the capacitor body CB to be connected to terminals 1311, 1321 exposed to the upper surface 120u of the dielectrics structure 120, and may be connected to the internal electrodes 131, 132 through the terminals 1311, 1321.

The external electrodes 141, 142 may include a first external electrode 141 connected to the first internal electrodes 131 and a second external electrode 142 connected to the second internal electrodes 132. For example, the first external electrode 141 may be connected to the first internal electrodes 131 through the first terminals 1311 exposed to the upper surface 120u of the dielectrics structure 120, and the second external electrode 142 may be connected to the second internal electrodes 132 through the second terminals 1321 exposed to the upper surface 120u of the dielectrics structure 120. The first external electrode 141 may not be connected to the second internal electrode 132, and the second external electrode 142 may not be connected to the first internal electrode 131. By arranging both the first external electrode 141 and the second external electrode 142 on the upper surface 120u of the dielectrics structure 120, the distance between the external electrodes 141, 142 can be minimized so that a capacitor having a low ESL characteristic can be provided.

The entire area of the external electrodes 141, 142 may be disposed on the upper surface 120u of the dielectrics structure 120. In other words, the external electrodes 141, 142 may be disposed only on the upper surface 120u of the dielectrics structure 120, and may not be disposed on the outer side surface 120s and the lower surface 1201 of the dielectrics structure 120. By arranging external electrodes 141, 142 only on the upper surface 120u of the dielectrics structure 120, the increase in capacitor size due to the arrangement of external electrodes 141, 142 can be minimized.

As materials for each of the external electrodes 141, 142, conductive materials may be used.

For example, nickel (Ni), copper (Cu), silver (Ag), tin (Sn), palladium (Pd), gold (Au), platinum (Pt), or metal alloy containing two or more of those may be used for the external electrodes 141, 142.

Each of the external electrodes 141, 142 may be composed of a plurality of layers. For example, the external electrodes 141, 142 may include a copper (Cu) layer, a nickel (Ni) layer, and a tin (Sn) layer sequentially arranged on the upper surface 120u of the dielectrics structure 120.

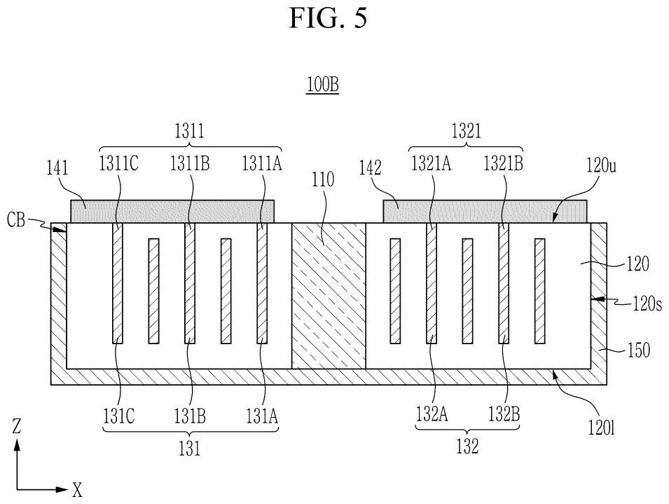

FIG. 5 is a cross-sectional view of a capacitor according to further embodiments of the present disclosure.

Referring to FIG. 5, the capacitor 100B may further include a molding material 150 covering at least a part of the capacitor body CB. The molding material 150 may improve the water resistance of capacitor 100B and prevent cracks.

In some embodiments, the molding material 150 may cover at least a portion of each of the side surfaces 120s and the lower surface 1201 of the dielectrics structure 120, and may further cover a lower surface of the axial core 110 exposed to the lower surface 1201 of the dielectrics structure 120. Also, the molding material 150 may not cover the upper surface 120u of the dielectrics structure 120 and the upper surface of the axial core 110 exposed to the upper surface 120u.

As materials for the molding material 150, an insulating material, for example, an epoxy molding compound (EMC), a thermosetting resin such as epoxy resin, or a thermoplastic resin such as polyimide may be used.

The molding material 150 may be formed, for example, by forming the internal electrodes 131, 132 and the dielectrics structure 120 surrounding the axial core 110 to form a capacitor body CB, forming the molding material 150 to cover the entire capacitor body CB, and then removing an upper region of the molding material 150 to expose the terminals 1311, 1321.

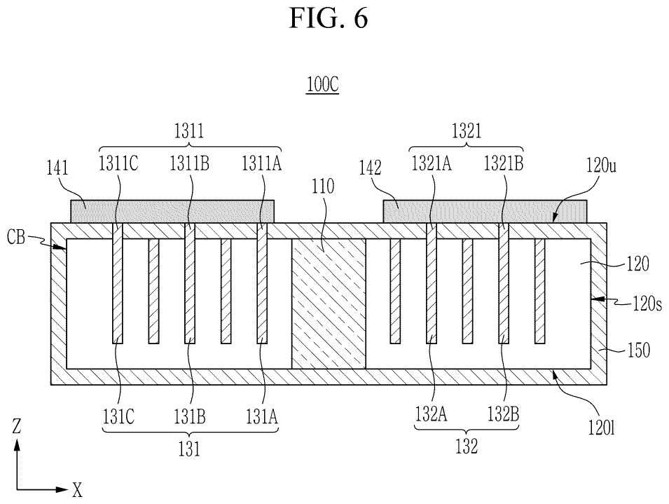

FIG. 6 is a cross-sectional view of a capacitor 100C according to further embodiments of the present disclosure.

Compared to the capacitor 100B illustrated in FIG. 5, in the capacitor 100C the molding material 150 may be extended to the upper surface 120u of the dielectrics structure 120. Therefore, the molding material 150 may fill the space between the upper surface 120u of the dielectrics structure 120 and the external electrodes 141, 142. Also, the terminals 1311, 1321 exposed at the upper surface 120u of the dielectrics structure 120 may have a structure embedded in and penetrating the molding material 150. The molding material 150 may be also extended to the upper surface of the axial core 110 exposed at the upper surface 120u of the dielectrics structure 120.

The molding material 150 may be formed by, for example, forming the terminals 1311, 1321 to protrude from the upper surface 120u of the dielectrics structure 120 when forming the capacitor body CB, forming the molding material 150 to cover the entire capacitor body CB, and then removing an upper region of the molding material 150 to expose the terminals 1311, 1321.

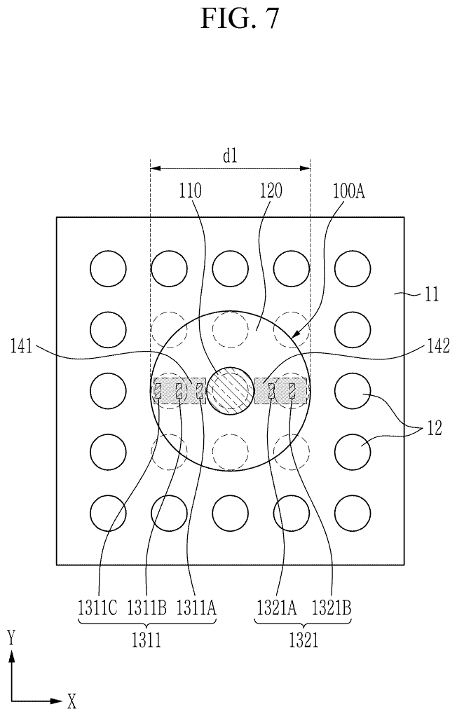

FIG. 7 shows a region of a substrate on which a capacitor according to an embodiment of the present disclosure is mounted.

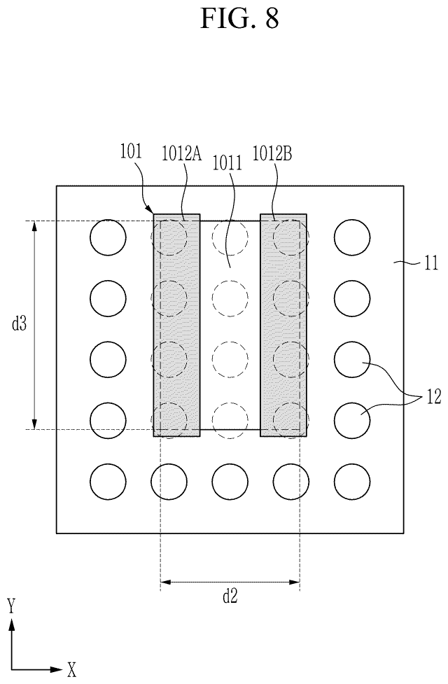

FIG. 8 shows a region of a substrate on which the capacitor according to Comparative Example 1 is mounted.

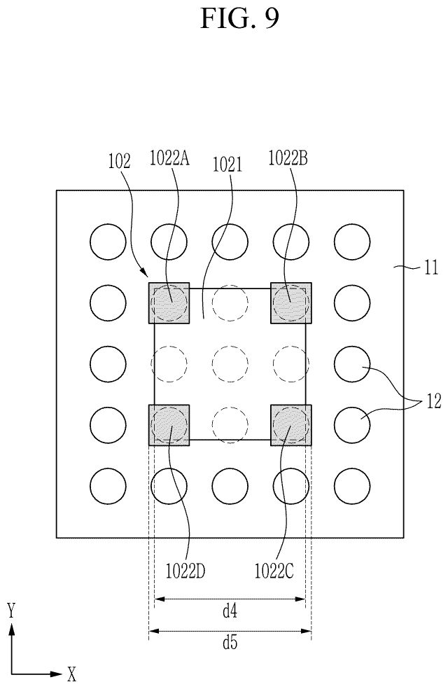

FIG. 9 shows a region of a substrate on which the capacitor according to Comparative Example 2 is mounted.

The capacitor according to the embodiment is a cylindrical capacitor with a diameter d1 of 610 μm and a thickness in the Z direction (Z) of 80 μm.

The capacitors according to Comparative Example 1 and Comparative Example 2 are a two-terminal LICC (low inductance ceramic capacitor) and a four-terminal LICC of hexahedral shape, which have the same or similar volume as the capacitor according to an embodiment, respectively. The capacitor 101 according to Comparative Example 1 includes a capacitor body 1011 and two external electrodes 1012A, and the capacitor 102 according to Comparative Example 2 includes a capacitor body 1021 and four external electrodes 1022A, 1022B, 1022C, 1022D.

In the capacitor according to Comparative Example 1, the length d2 in the X direction (X) is 0.50 mm, and the length d3 in the Y direction (Y) is 1.00 mm.

According to Comparative Example 2, the length d4 excluding external electrodes 141, 142 in the X direction (X) and Y direction (Y) is 580 μm, and the length d5 including external electrodes 1022A, 1022B, 1022C, 1022D in the X direction (X) and Y direction (Y) is 600 μm. Additionally, the thickness of the capacitor in the Z direction (Z) according to Comparative Example 2 is 70 μm.

The capacitor may be disposed with solder balls 12 on a substrate (e.g., AP package substrate) 11. Since the capacitor is disposed between 12 solder balls, the degree of depopulation of solder balls 12 is determined depending on the mounting area of the capacitor. Since the number of solder balls can affect the signal integrity and electric power stability of electronic devices, it is important to reduce the depopulation of solder balls due to the capacitor.

Referring to FIG. 7 to FIG. 9, the capacitor according to the embodiment causes a depopulation of nine solder balls, the capacitor according to Comparative Example 1 causes a depopulation of twelve solder balls, and the capacitor according to Comparative Example 2 causes a depopulation of nine solder balls. That is, the capacitor according to embodiment causes a smaller depopulation of solder balls than the capacitor according to Comparative Example 1.

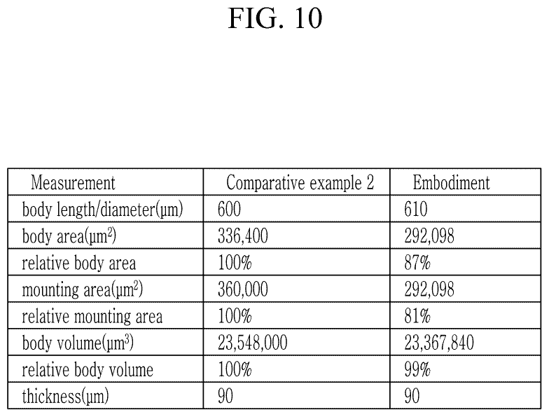

FIG. 10 is a table comparing capacitors according to an embodiment and Comparative Example 2.

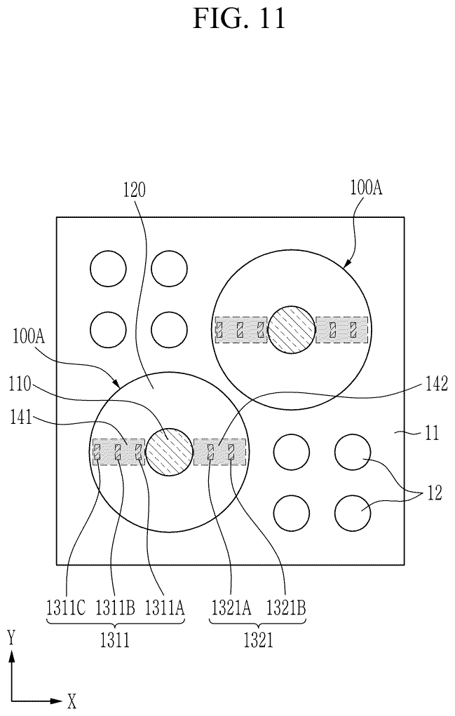

FIG. 11 shows a region of a substrate on which the capacitor according to an embodiment of the present disclosure is mounted.

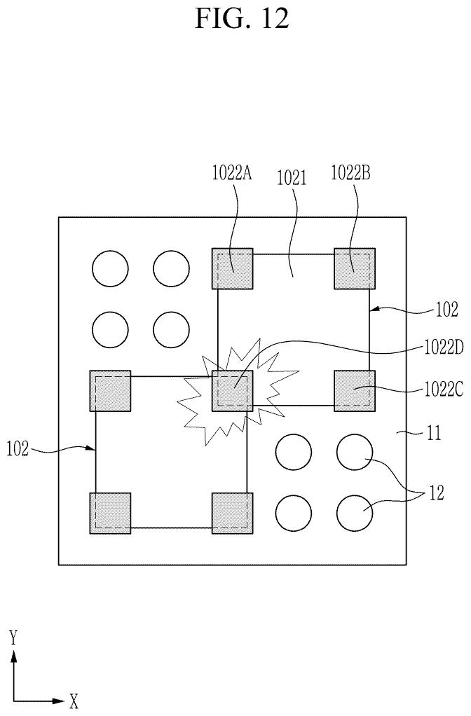

FIG. 12 shows a region of the substrate on which the capacitor according to Comparative Example 2 is mounted.

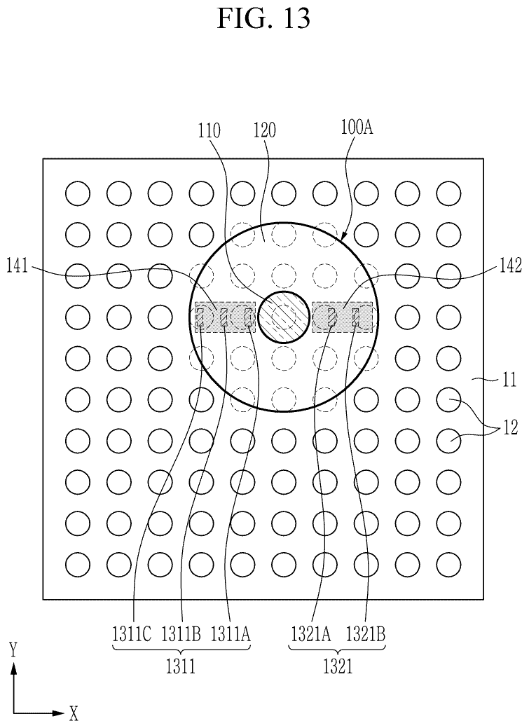

FIG. 13 shows a region of a substrate on which a capacitor according to an embodiment of the present disclosure is mounted together with solder balls having small pitches.

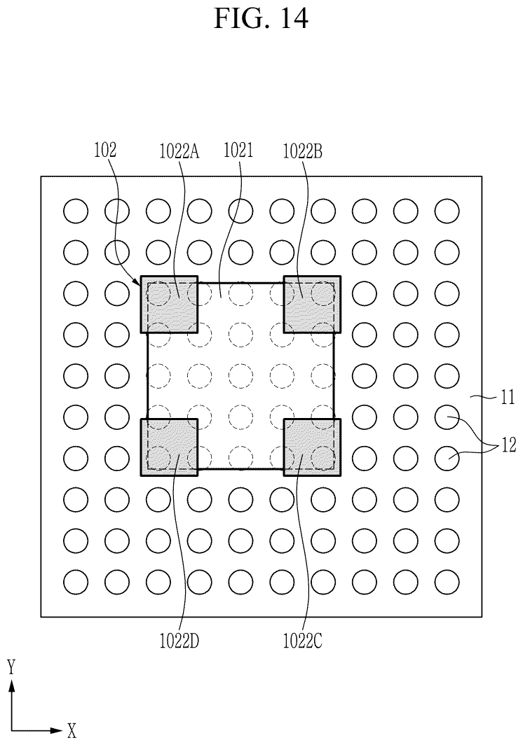

FIG. 14 shows a region of a substrate on which a capacitor according to Comparative Example 2 is mounted together with solder balls having small pitches.

Referring to FIG. 10, the mounting area of the capacitor according to the embodiment is about 81% of the mounting area of the capacitor according to Comparative Example 2 (which has a similar volume to the capacitor according to the embodiment), and it can be seen that it has a smaller mounting area relative to the volume compared to the capacitor of the hexahedral shape.

Referring to FIG. 11 and FIG. 12, it can be seen that the capacitor according to the embodiment has an advantage in degree of freedom in mounting because of the smaller mounting area, compared to the capacitor according to Comparative Example 2.

Also, referring to FIG. 13 and FIG. 14, when disposing the capacitor with solder balls having small pitches on a substrate, the capacitor according to the embodiment causes less depopulation of solder balls than the capacitor according to Comparative Example 2. In other words, it can be seen that, as the pitch of the solder balls becomes smaller, use of the capacitor according to the embodiments is advantageous in terms of depopulation of solder balls.

FIG. 15 is a drawing illustrating a method for manufacturing a capacitor body according to some embodiments of the present disclosure.

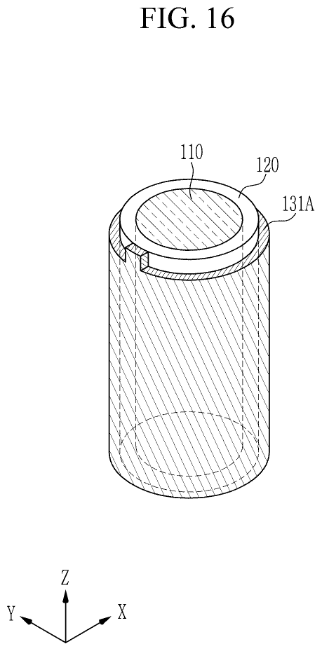

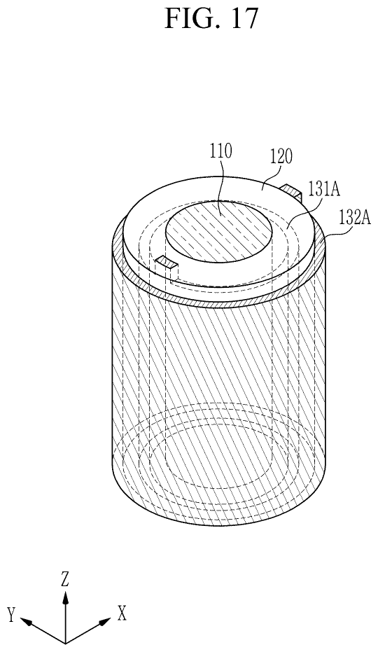

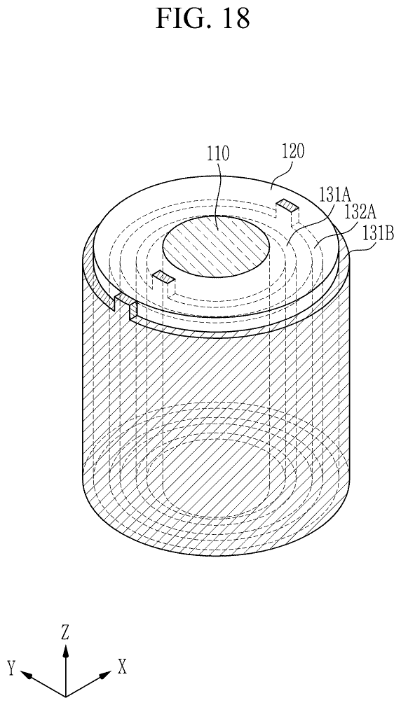

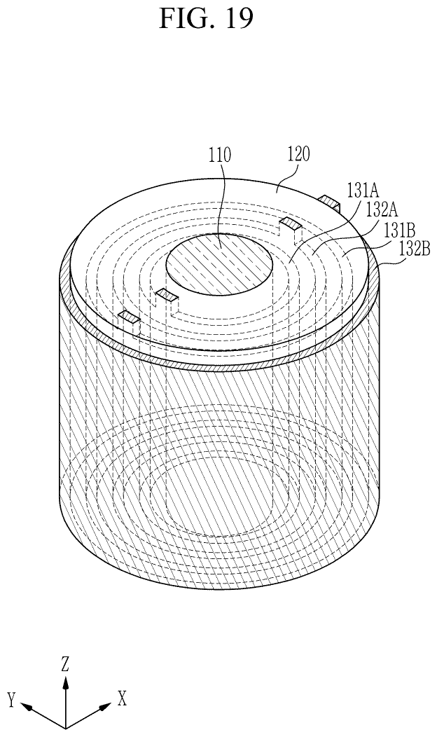

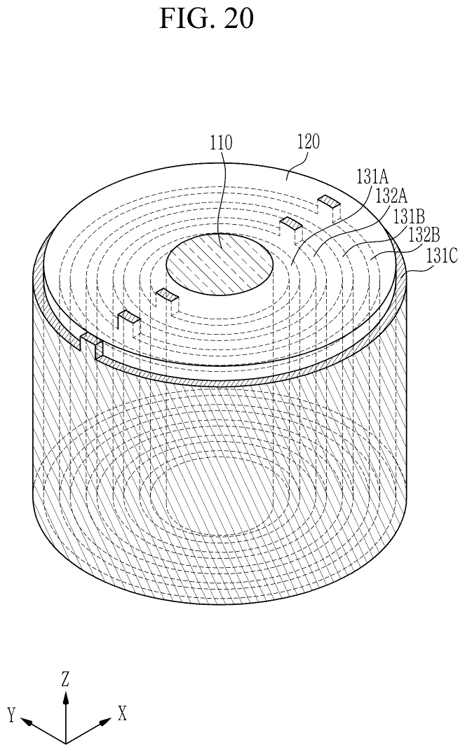

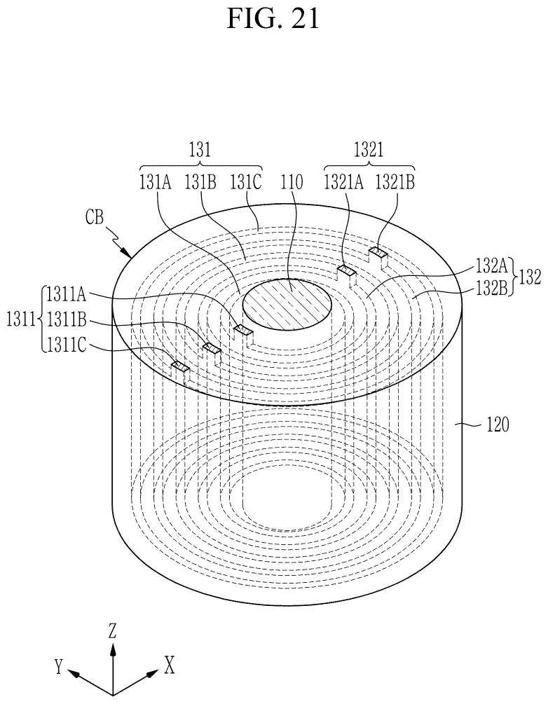

FIG. 16 to FIG. 21 are perspective views of the capacitor body in each the manufacturing steps.

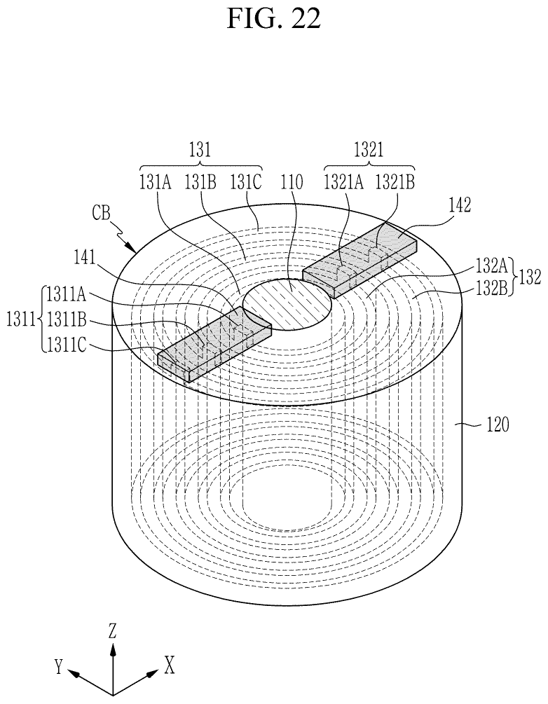

FIG. 22 is a drawing illustrating the process of forming external electrodes on a capacitor body.

A capacitor manufacturing method according to some embodiments may include forming a capacitor body CB (see FIG. 2) and forming external electrodes 141, 142 on the capacitor body CB.

First, referring to FIG. 15 to FIG. 21, forming a capacitor body CB may be performed by alternately winding dielectric material sheets 120′ (which are wound around the axial core 110 to form a dielectrics structure 120 of a capacitor 100A), and internal electrode sheets 131′, 132′ (which form internal electrodes 131, 132). FIG. 16 to FIG. 21 illustrate, respectively, the steps (a), (b), (c), (d), (c), and (f) of FIG. 15 wherein and whereby the dielectric material sheets 120′ and internal electrode sheets 131′ and 132′ are wound around the axial core 110 to form the capacitor body CB construction including the dielectrics structure 120 and the internal electrodes 131, 132.

The internal electrode sheets 131′, 132′ may include a first internal electrode sheet 131′ forming the first internal electrode 131 of the capacitor 100A and a second internal electrode sheet 132′ forming the second internal electrode 132. The first internal electrode sheet 131′ and the second internal electrode sheet 132′ may respectively include a first terminal 1311 and a second terminal 1321 disposed at an end thereof.

The first internal electrode sheet 131′ and the second internal electrode sheet 132′ may be alternately wound around the dielectric material sheets 120′. For example, a capacitor body CB may be formed by sequentially winding a dielectric material sheet 120′, a first internal electrode sheet 131A′, a dielectric material sheet 120′, a second internal electrode sheet 132A′, a dielectric material sheet 120′, a first internal electrode sheet 131B′, a dielectric material sheet 120′, a second internal electrode sheet 132B′, a dielectric material sheet 120′, a first internal electrode sheet 131C′, and a dielectric material sheet 120′ around an axial core 110.

In order to alternately wind dielectric material sheets 120′ and internal electrode sheets 131′, 132′ around an axial core 110, forming a capacitor body CB according to some embodiments may include arranging the dielectric material sheets 120′ and internal electrode sheets 131′, 132′ on a substrate or base 13 such that they are spaced apart in an X direction (X), and winding the dielectric material sheets 120′ and internal electrode sheets 131′, 132′ around the axial core 110.

In winding the dielectric material sheets 120′ and the internal electrode sheets 131′, 132′, the dielectric material sheets 120′ and the internal electrode sheets 131′, 132′ arranged on the base (e.g., conveyor belt) 13 may be sequentially wound around the axial core 110 along the X direction (X). For example, by rotating the axial core 110 about its axis (which is arranged in or aligned with the Z direction (Z)), the dielectric material sheets 120′ and internal electrode sheets 131′, 132′ may be wound around the axial core 110 in the X direction (X). As another example, by moving the dielectric material sheets 120′ and the internal electrode sheets 131′ and 132′ arranged on the base 13 in the opposite direction (left direction in the drawing) of the X direction (X) and rotating the axial core 110 about an axis (arranged in the Z direction (Z)), the dielectric material sheets 120′ and the internal electrode sheets 131′ and 132′ may be wound around the axial core 110.

In winding the dielectric material sheets 120′ and the internal electrode sheets 131′, 132′, the dielectric material sheets 120′ and the internal electrode sheets 131′, 132′ may be separated from the base 13 and wound around the axial core 110. If necessary, a film may be additionally placed between the base 13 and the dielectric material sheets 120′ and the internal electrode sheets 131′, 132′ for easy separation thereof.

In order for the first internal electrode sheet 131′ and the second internal electrode sheet 132′ to be alternately wound around the dielectric material sheets 120′, the first internal electrode sheet 131′ and the second internal electrode sheet 132′ may be alternately arranged between the dielectric material sheets 120′ on the base 13.

On the base 13, the length D1, D2 of each of the dielectric material sheets 120′ and the internal electrode sheets 131′ and 132′ in the X direction (X) may be gradually increased as farther disposed it is along the X direction (X) (or as later wound it is). This is because the diameter increases as the sheets are wound around the core shaft 110 and each winding has as greater diameter than the preceding winding.

On the base 13, the gap D5 between the dielectric material sheet 120′ and the internal electrode sheets 131′, 132′ may be appropriately adjusted so that the terminals 1311 and 1321 in the capacitor 100A are positioned at the designed positions without affecting winding of the adjacent dielectric material sheets 120′ and the internal electrode sheets 131′, 132′ around the axial core 110. For example, on the base 13, the space between the dielectric material sheet 120′ and the internal electrode sheets 131′ and 132′ may be greater than the wound diameter of a configuration (e.g., the configuration disposed on the left in the drawing) of one of those. Therefore, the space between the dielectric material sheet 120′ and the internal electrode sheets 131′, 132′ on the base 13 may be gradually increased as the spaces are farther disposed along the X direction (X).

On the base 13, the terminal 1311, 1321 may be disposed on an upper end (an end in the Z direction (Z)) of the internal electrode sheet 131′, 132′ to be exposed on a surface where the external electrode 141, 142 of the capacitor body CB is formed. For example, on the base 13, the first terminal 1311 may be disposed at the upper end of the first internal electrode sheet 131′, and the second terminal 1321 may be disposed at the upper end of the second internal electrode sheet 132′. In FIG. 15, the Z direction (Z) is set to a direction from the upper surface to the lower surface of the axial core 110, consistent with FIG. 1.

Also, the dielectric material sheets 120′ and the internal electrode sheets 131′, 132′ may be aligned so that an imaginary line connecting upper ends (ends in the Z direction (Z)) of the terminals 1311, 1321 and upper ends (ends in the Z direction (Z)) forms a straight line on the base 130.

In order to form a structure wherein the internal electrodes 131, 132 are embedded in the dielectrics structure 120, the length D3 of the dielectric material sheet 120′ in the Z direction (Z) may be longer than the length D4 of the internal electrode sheets 131′ and 132′ in the Z direction (Z), on the base 130. The first internal electrodes 131 and the second internal electrodes 132 may not exposed to the lower surface 1201 of the dielectrics structure 120 in the capacitor body CB, by forming the length D3 of the dielectric material sheet 120 longer than the length D4 of the internal electrode sheets 131′, 132′ while the imaginary line VL connecting the upper ends of terminals 1311, 1321 and the upper ends of dielectric material sheets 120′ forms a straight line, on the base 130.

The positions of the first terminals 1311 and the second terminals 1321 may be appropriately adjusted considering the exposed position from the dielectrics structure 120. For example, the first terminal 1311 may be disposed at an end (a left end in the drawing) of the first internal electrode sheet 131′ in the X direction (X) and the second terminal 1321 may be disposed at the center of the second internal electrode sheet 132′ in the X direction (X) on the base 130, so that the first terminals 1311 and the second terminals 1321 are disposed in opposite directions with respect to the axial core 110 after the internal electrode sheets 131′ and 132′ are wound.

If necessary, forming the capacitor body CB may further include firing the dielectric material sheets 120′ and the internal electrode sheets 131′, 132′ after alternately winding dielectric material sheets 120′ and internal electrode sheets 131′, 132′ around the core shaft 110. The firing temperature may be determined depending on the material of the dielectric material sheets 120′ and the internal electrode sheets 131′, 132′, and, it may be in the range of from about 1000° C. to 1400° C., for example.

Referring to FIG. 22, the external electrodes 141, 142 may be formed on the capacitor body CB to be respectively connected to terminals 1311, 1321. For example, the first external electrode 141 may be formed on the first terminals 1311 and connected to the first terminals 1311, and the second external electrode 142 may be formed on the second terminals 1321 and connected to the second terminals 1321.

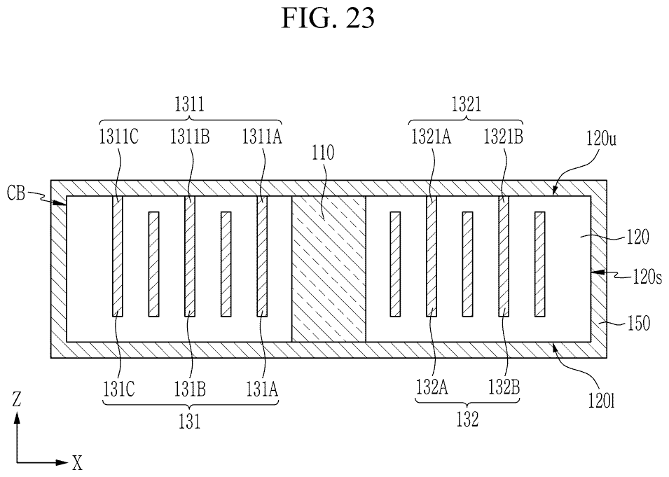

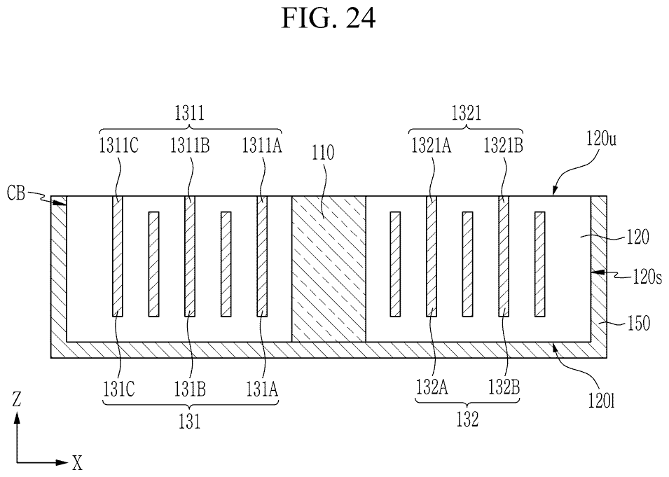

FIG. 23 and FIG. 24 illustrate example methods for forming a molding material on a capacitor body.

Referring to FIG. 23 and FIG. 24, a capacitor manufacturing method according to some embodiments may further include molding the capacitor body CB with a molding material 150 and removing a part of the molding material 150 to expose the terminals 1311, 1321.

Molding with molding material 150 may be performed, for example, by impregnating and immersing the capacitor body CB in the molding liquid by compression molding and applying heat and/or pressure. During molding, the entire area of the capacitor body CB may be covered with molding material 150. Therefore, a process to expose terminals 1311, 1321 for connection to external electrodes 141, 142 may be further performed. Removing the molding material 150 may be performed by grinding the molding material 150, for example.

By forming the external electrodes 141, 142 on the capacitor body CB to be connected to terminals 1311, 1321 after grinding the molding material 150, the capacitor 100B shown in FIG. 5 may be manufactured.

In order to form the capacitor body CB such that the terminals 1311, 1321 protrude to the upper surface 120u of the dielectrics structure 120, a capacitor 100C as shown in FIG. 6 may be manufactured by molding with a molding material 150 and removing a upper portion.

Although the embodiments of the present disclosure have been described in detail above, the scope of the present disclosure is not limited thereto, and various modifications and improvements can be made by those skilled in the art using the basic concept of the present disclosure defined in the following claims, and they fall within the scope of the present disclosure.

Additionally, the embodiments of the present disclosure are not independent of each other and may be implemented in combination with each other unless specifically contradictory. Therefore, the combinations of the embodiments of the present disclosure should also be considered as included in the present disclosure.

What is claimed is:

1. A capacitor comprising:
a capacitor body including:
a dielectrics structure; and
a plurality of internal electrodes embedded in the dielectrics structure and spaced apart from one another in a direction from a side surface of the dielectrics structure to inside of the dielectrics structure; and
an external electrode disposed on the capacitor body and connected to the internal electrodes;
wherein each of the plurality of internal electrodes circumferentially surrounds another internal electrode disposed further inside of the dielectrics structure.

2. The capacitor of claim 1, wherein each of the internal electrodes includes a terminal exposed at an upper surface of the dielectrics structure to be connected to the external electrode.

3. The capacitor of claim 1, wherein an entire area of the external electrode is disposed on an upper surface of the dielectrics structure.

4. The capacitor of claim 1, wherein
the capacitor body further includes an axial core circumferentially surrounded by the dielectrics structure.

5. The capacitor of claim 4, wherein the axial core contains silicon.

6. The capacitor of claim 1, wherein the internal electrodes are not exposed at a lower surface of the dielectrics structure.

7. The capacitor of claim 1, further including a molding material covering at least a portion of each of the side surface and a lower surface of the dielectrics structure.

8. The capacitor of claim 7, wherein the molding material is extended to an upper surface of the dielectrics structure.

9. The capacitor of claim 1, wherein the dielectrics structure is cylindrical.

10. A capacitor comprising:
a capacitor body including:
an axial core;
a dielectrics structure surrounding the axial core;
a plurality of first internal electrodes embedded in the dielectrics structure and each including a respective first terminal exposed at an upper surface of the dielectrics structure; and
a plurality of second internal electrodes embedded in the dielectrics structure, electrically insulated from the first internal electrodes, and each including a respective second terminal exposed to the upper surface of the dielectrics structure; and
first and second external electrodes disposed on the capacitor body, wherein the first external electrode is connected to the first terminal and the second external electrode is connected to the second terminal.

11. The capacitor of claim 10, wherein the first internal electrodes and the second internal electrodes surround the axial core and are spaced apart from each other in a direction away from the axial core.

12. The capacitor of claim 11, wherein the first internal electrodes and the second internal electrodes are alternately arranged in a direction away from the axial core.

13. The capacitor of claim 10, wherein the first terminal and the second terminal are arranged on the dielectrics structure in opposite directions with respect to the axial core.

14. The capacitor of claim 10, wherein an entire area of each of the first external electrode and the second external electrode are disposed on the upper surface of the dielectrics structure.

15. A capacitor manufacturing method comprising:
forming a capacitor body by alternately winding dielectric material sheets and internal electrode sheets around an axial core, each of the internal electrode sheets including a respective terminal; and
forming an external electrode connected to the terminals on the capacitor body,
wherein the forming the capacitor body includes arranging the dielectric material sheets and the internal electrode sheets spaced apart from each other in a first direction on a base, and winding the dielectric material sheets and the internal electrode sheets around the axial core.

16. The capacitor manufacturing method of claim 15, wherein:
during the step of winding the dielectric material sheets and the internal electrode sheets, the dielectric material sheets and the internal electrode sheets arranged on the base are sequentially wound around the axial core along the first direction; and
on the substrate, a length of each of the dielectric material sheets and the internal electrode sheets in the first direction gradually increases as the dielectric material sheets and the internal electrode sheets are located farther along the first direction.

17. The capacitor manufacturing method of claim 15, wherein each of the terminals is arranged at an end of its respective internal electrode sheet in a second direction perpendicular to the first direction, on the base.

18. The capacitor manufacturing method of claim 17, wherein:
the internal electrode sheets include a first internal electrode sheet and a second internal electrode sheet alternately wound around the dielectric material sheets; and
a terminal of the first internal electrode sheet is disposed at an end of the first internal electrode in the first direction, and a terminal of the second internal electrode sheet is disposed at a center of the second internal electrode in the first direction, on the base.

19. The capacitor manufacturing method of claim 15, wherein
a length of the dielectric material sheet in a second direction perpendicular to the first direction is longer than the length of the internal electrode sheet in the second direction, on the base.

20. The capacitor manufacturing method of claim 15, further comprising:
molding the capacitor body with a molding material; and
removing a portion of the molding material to expose the terminals.
